(19) United States
(12) Patent Application Publication
(10) Pub. No.: US 2010/0234005 A1
(43) Pub. Date: Sep. 16, 2010

(54) System for Selectively Limiting the Function of a Communication Device

(76) Inventor: Scott Bloomquist, Mooresburg, TN (US)

Correspondence Address: PITTS AND BRITTIAN P C, P O BOX 51295, KNOXVILLE, TN, 37950-1295, US

(21) Appl. No.: 12/400,841

(22) Filed: Mar. 10, 2009

(51) Int. Cl. H04W 4/00

(52) U.S. Cl. 455/418; 455/412.1

(57) ABSTRACT

Described is a system and method for limiting the function of a subservient communication device using a dominant communication device. More specifically, the dominant communication device is capable of limiting the function of the subservient communication device when the user of the subservient communication device does not respond to an attempted communication from the dominant communication device. The function of the subservient communication device remains limited until it establishes communication with the dominant communication device or, in certain embodiments, a secondary communication device.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention pertains to a system for limiting the function of a communication device upon the occurrence of a first predefined event and for reestablishing the function of the device upon the occurrence of a second predefined event.

### BRIEF SUMMARY OF THE INVENTION

In accordance with the various features of the present invention there is provided a system and method for limiting the function of a subservient communication device using a dominant communication device. More specifically, the system includes the subservient communication device, the dominant communication device, a secondary communication device (in certain embodiments), and a message center, the communication devices being, for example, cellular telephones. When the dominant communication device attempts to communicate with the subservient communication device and the subservient communication device does not respond, the dominant communication device is enabled to disable the subservient communication device. When the user of the dominant communication device chooses to disable the subservient communication device, the user records a message that is stored at the message center. When disabled, the subservient communication device is limited to communication with the dominant communication, the secondary communication device (in certain embodiments), and the message center by way of the dominant communication device. The subservient communication device remains disabled until it establishes communication with the dominant communication device, the secondary communication device (in certain embodiments), or the message center by way of the dominant communication device. More specifically, when the subservient communication device is disabled and its user attempts to establish communication with the dominant communication device and the user of the dominant communication device is not responsive thereto, the dominant communication device automatically establishes communication between the subservient communication device and the message center such that the recorded message is accessible by the user of the subservient communication device. When the user accesses the message, the subservient communication device is re-enabled just as if it had established communication with the dominant communication device.

Considering the above discussion, the user of the dominant communication device is able to encourage communication with and from the user of the subservient communication device when such communication is an emergency or merely desired. Such communication can be direct communication between the users or can be indirect by way of the message. Additionally, the secondary communication device can be, for example, that of an emergency service provider such that the subservient communication device, even when disabled, is capable of establishing communication with someone other than the user of the dominant communication device in the event of an emergency.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the system in accordance with the various features of the present invention;

FIG. 2 is a flow diagram illustrating one embodiment of the disablement of the subservient communication device of FIG. 1; and

FIG. 3 is a flow diagram illustrating one embodiment of the enablement of the subservient communication device of FIG. 1.

### DETAILED DESCRIPTION OF THE INVENTION

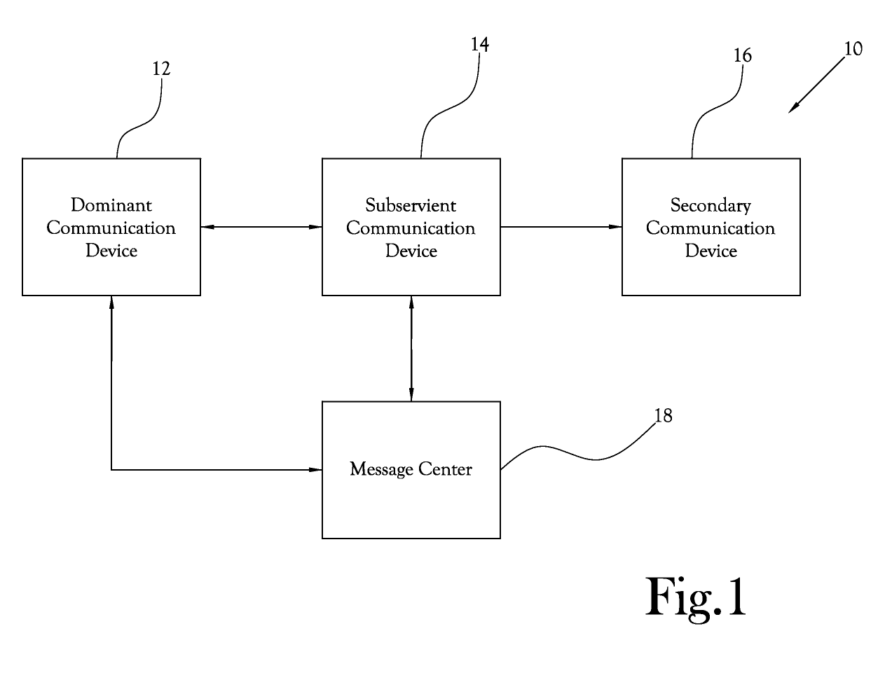

The present invention provides a system and method for limiting the function of a subservient communication device using a dominant communication device. More specifically, the dominant communication device is capable of limiting the function of the subservient communication device when the user of the subservient communication device does not respond to an attempted communication from the dominant communication device. The function of the subservient communication device remains limited until it establishes communication with the dominant communication device or, in certain embodiments, a secondary communication device. A block diagram of one embodiment of the system in accordance with the various features of the present invention is illustrated generally at 10 in FIG. 1.

In the illustrated embodiment, the system 10 includes a dominant communication device 12, a subservient communication device 14, a secondary communication device 16, and a message center 18, each being terminals on a communications network and, accordingly, each being capable of communication with one another by way of the network. Each of the dominant communication device 12, the subservient communication device 14, and the secondary communication device 16 can be any type of device capable of communication across the communications network. For example, each of the communication devices can be one of a cellular telephone, such as one capable text messaging, and a land-line telephone. The subservient communication device 14 is adapted to operate in an enabled mode of operation and a disabled mode of operation. When enabled, the subservient communication device 14 is fully functional, limited only by the parameters of the device itself. When disabled, the subservient communication device 14 is limited to communication with the dominant communication device 12, the message center 18 by way of the dominant communication device 12, or, in certain embodiments, the secondary communication device 16. The subservient communication device 14 is disabled by the dominant communication device 12 at the discretion of the user of the dominant communication device 12 when the subservient communication device 14 does not respond to an attempted communication from the dominant communication device 12. A communication includes any type of communication by the communication devices. For example, a communication can be a telephone call or a text message. The subservient communication device 14 is re-enabled when it establishes communication with the dominant communication device 12, the message center 18 by way of the dominant communication device 12, or, in certain embodiments, the secondary communication device 16.

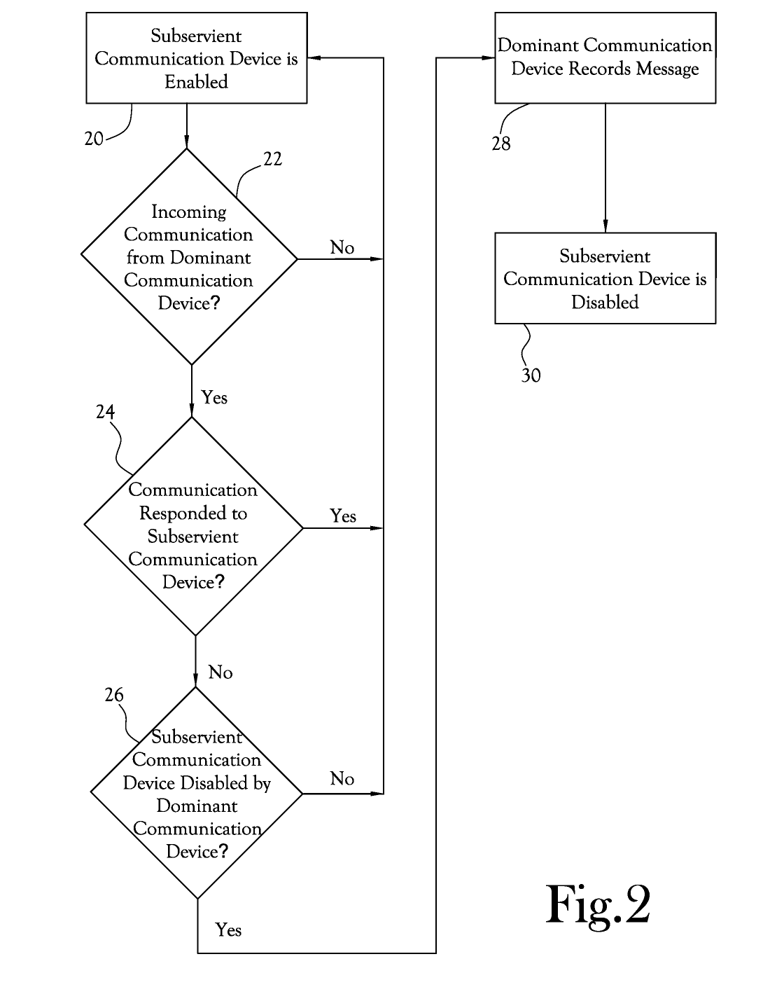

FIG. 2 is a flow diagram illustrating the operation of one embodiment of the system 10, whereby the subservient communication device 14 is disabled by the dominant communication device 12. Generally, and as illustrated at 20, the subservient communication device 14 operates in the enabled mode of operation. When the subservient communication device 14 has an incoming communication, it determines whether the incoming communication is from the dominant communication device 12, as illustrated at 22. When the incoming communication is not from the dominant communication device 12, the subservient communication device 14 continues to be enabled. However, when the incoming communication is from the dominant communication device 12, the subservient communication device 14 determines whether the user of the subservient communication device 14 responds to the incoming communication, as illustrated at 24. Stated differently, the subservient communication device 14 determines whether the user, for example, answers the incoming call or accesses the incoming text message. When the user responds to the incoming communication, the subservient communication device 14 continues to be enabled. When the user does not respond to the incoming communication, the subservient communication device 14 provides the user of the dominant communication device 12 with the option of disabling the subservient communication device 14. For example, in one embodiment, the subservient communication device 14 provides the user of the dominant communication device 12 with a menu having the options of discontinuing the communication, recording a voice mail, leaving a text message, or disabling the subservient communication device 14. However, it should be noted that the subservient communication device 14 can provide the user of the dominant communication device 12 with options other than those listed above without departing from the scope or spirit of the present invention. It should also be noted that, in one embodiment, the subservient communication device 14 password protects the disabling option such that the user of the dominant communication device 12 must enter a predetermined password to access the disabling option. In yet another embodiment, the subservient communication device 14 is automatically disabled when its user does not respond to an attempted communication from the dominant communication device 12.

In the event the user of the dominant communication device 12 chooses not to disable the subservient communication device 14, as illustrated at 26, the subservient communication device 14 continues to be enabled. When the dominant communication device 12 does disable the subservient communication device 14, as illustrated at 26, the user of the dominant communication device 12 records a message that is stored at the message center 18, as illustrated at 28. After being stored at the message center 18, the message is accessible by the subservient communication device 14 in accordance with subsequent discussion. In one embodiment, the message center 18 is integrated within the dominant communication device 12, such that the message is stored and accessible from the dominant communication device 12. In another embodiment, such as that illustrated at FIG. 1, the message center 18 is a database that is independent and remote from the dominant communication device 12. After the user of the dominant communication device 12 records the message, the subservient communication device 14 is disabled, as illustrated at 30.

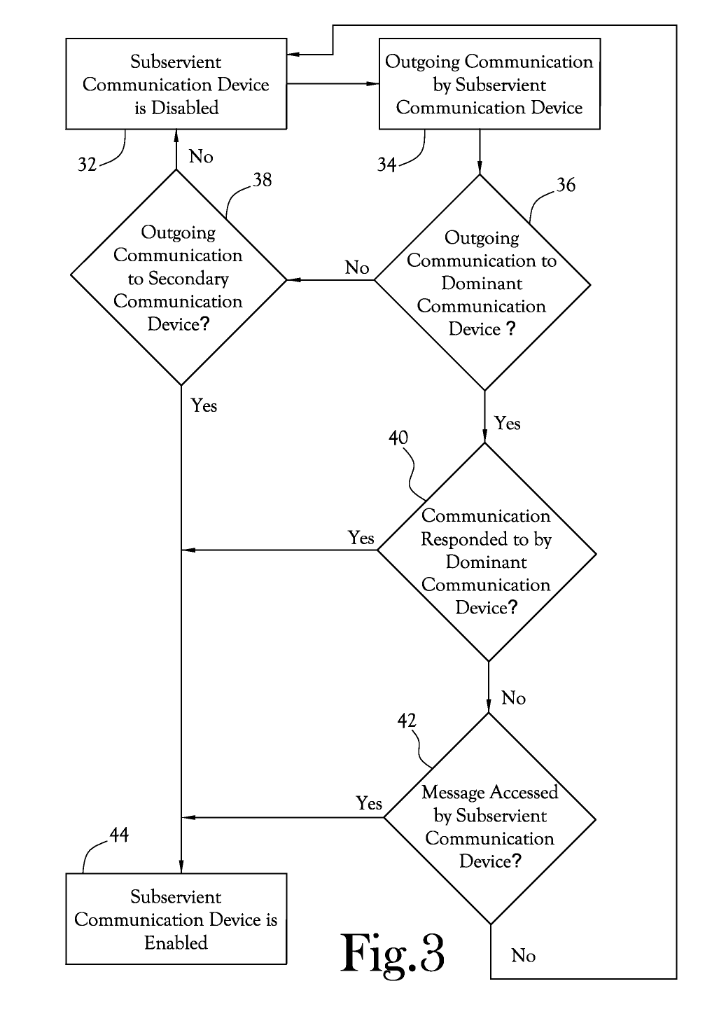

FIG. 3 is a flow diagram illustrating the operation of one embodiment of the system 10, whereby the subservient communication device 14 is re-enabled in accordance with the various features of the present invention. Accordingly, as illustrated at 32, the subservient communication device 14 operates in the disabled mode of operation after being disabled by the dominant communication device 12. When the user of the subservient communication device 14 attempts to make an outgoing communication, as illustrated at 34, the subservient communication device 14 determines whether the outgoing communication is to the dominant communication device 12, as illustrated at 36. When the subservient communication device 14 determines that the outgoing communication is not to the dominant communication device 12, the subservient communication device 14 determines whether the outgoing communication is to the secondary communication device 16, as illustrated at 38. When the subservient communication device 14 determines that the outgoing communication is not to the secondary communication device 16, the subservient communication device 14 remains disabled. However, when the subservient communication device 14 determines that the outgoing communication is to the secondary communication device 16 and communication is established therebetween, the subservient communication device 14 is re-enabled such that it is fully functional, as illustrated at 44.

Returning to 36, when the subservient communication device 14 determines that the outgoing communication is to the dominant communication device 12, the subservient communication device 14 determines whether the user of the dominant communication device 12 responds to the outgoing communication, as illustrated at 40. When the user of the dominant communication device 12 responds to the outgoing communication, that is, for example, answers the outgoing call or accesses the outgoing text message, the subservient communication device 14 is re-enabled such that it is fully functional. In the event the user of the dominant communication device 12 does not respond to the outgoing communication, the subservient communication device 14 automatically establishes communication with the message center 18. After the subservient communication device 14 establishes communication with the message center 18, the user chooses whether to access the message, that is, listen to the message, as illustrated at 42. In one embodiment, the message is password protected such that the user of the subservient communication device 14 must enter a password to access the message. In another embodiment, the message center 18 identifies the subservient communication device 14 and automatically provides the subservient communication device 14 with access to the message. When the user of the subservient communication device 14 accesses the message, the subservient communication device 14 is re-enabled such that it is fully functional, as illustrated at 44. However, in the event the user of subservient communication device 14 chooses not to access the message, the subservient communication device 14 remains disabled.

Considering the above discussion, the user of the dominant communication device 12 is able to disable the subservient communication device 14 when the user of the subservient communication device 14 is not responsive to an attempted communication from the dominant communication device 12. Once disabled, the subservient communication device 14 remains disabled until the user of the subservient communication device 14 establishes some sort of communication with the user of the dominant communication device 12, either directly or by way of the message, or, in certain embodiments, with the secondary communication device 16. For example, in one application of the system 10, the dominant communication device 12 is a cellular telephone carried and operated by a parent, and the subservient communication device 14 is a cellular telephone carried and operated by a child. When the parent desires communication with the child, for whatever reason, such as in the case of an emergency or when the child is not home by curfew, the parent attempts to communicate with the child, for example, by way of a telephone call. In the event the child does not answer the parent's call, the parent has the option of disabling the child's phone. When the parent elects to disable the child's phone, the parent is prompted to record the message. If there is an emergency, the parent can detail the emergency in the message. On the other hand, if the child has broken curfew, the parent can provide instructions to the child in the message. Once the child's phone is disabled, the child cannot use its phone to establish communication with any communication device other than that of the parent's or, in certain embodiments, the secondary communication device 16.

In the event the child returns the parent's call, and the parent answers the returned call, communication is established between the parent and the child such that the parent is able provide the child with the desired information. Accordingly, when such communication is established, the child's phone is re-enabled to its fully functional mode of operation. In the event the child returns the parent's call, but the parent does not answer the call, the message recorded by the parent is made available to the child. When the child accesses the message, the child is provided with the information recorded by the parent. When communication between the parent and the child is established by the child accessing the message, the child's phone is re-enabled to its fully functional mode of operation. In the event the child returns the parent's call, the parent the does not answer the call, and the child does not access the message, the child's phone remains disabled.

In the above-discussed parent/child application of the system 10, a logical secondary communication device 16 would be the telephones of an emergency service provider, such as that reached by dialing 911. Another logical secondary communication device 16 would be the telephone of a close friend or family member. In accordance with the above discussion, having the secondary communication device 16 enables the child to contact an emergency service provider even when the child's phone is disabled. It should be noted that the secondary communication device 16 can be that of a person or establishment other than an emergency service provider without departing from the scope or spirit of the present invention. It should also be noted that the secondary communication device 16 can be any number of secondary communication devices 16 without departing from the scope or spirit of the present invention.

Although a specific application of the system 10 is discussed above, it should be noted that the system 10 is not limited to such an application. For example, in one application, the dominant communication device 12 is operated by an employer and the subservient communication device 14 is operated by an employee. It should also be noted that the system 10 does not require the secondary communication device 16 to remain within the scope or spirit of the present invention. Additionally, it should be noted that, in one embodiment, the system 10 does not include the message center 18, such that the subservient communication device 14 is re-enabled only when it establishes a line of communication with the dominant communication device 12.

From the foregoing description, those skilled in the art will recognize that a system and method for limiting the function of a subservient communication device using a dominant communication device offering advantages over the prior art has been provided. More specifically, the dominant communication device is capable of limiting the function of the subservient communication device when the user of the subservient communication device does not respond to an attempted communication from the dominant communication device. The function of the subservient communication device remains limited until it establishes communication with the dominant communication device or, in certain embodiments, a secondary communication device.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A system comprising:
a subservient communication device adapted to be enabled and disabled, said subservient communication device being fully functional when enabled;
a secondary communication device adapted for communication with said subservient communication device; and
a dominant communication device adapted for communication with said subservient communication device, said dominant communication device adapted to disable said subservient communication device when said subservient communication device is not responsive to an attempted communication from said dominant communication device, said subservient communication device being limited to communication with said dominant communication device and said secondary communication device when disabled, said subservient communication device being enabled when, after being disabled, it establishes communication with one of said dominant communication device and said secondary communication device.

2. The system of claim 1 wherein said subservient communication device is a cellular telephone.

3. The system of claim 1 wherein said dominant communication device is a cellular telephone.

4. The system of claim 1 wherein communication among said subservient communication device, said dominant communication device, and said secondary communication device is selected from the group consisting of communication by way of a telephone call and communication by way of text messaging.

5. The system of claim 1 further comprising a message center, said message center being adapted to store a message recorded by a user of said dominant communication device when said subservient communication device is not responsive to the attempted communication from said dominant communication device.

6. The system of claim 5 wherein said message center is integrated within said dominant communication device.

7. The system of claim 5 wherein said message center is independent of said dominant communication device.

8. The system of claim 5 wherein said subservient communication device establishes communication with said dominant communication device for the purpose of enabling said subservient communication device when said subservient communication device accesses the message stored at said message center.

9. The system of claim 1 wherein said secondary communication device is that of an emergency services provider.

10. A system comprising:
a subservient communication device adapted to be enabled and disabled, said subservient communication device being fully functional when enabled;
a secondary communication device adapted for communication with said subservient communication device;
a message center adapted for communication with said subservient communication device; and
a dominant communication device adapted for communication with said subservient communication device and said message center, said dominant communication device adapted to disable said subservient communication device when said subservient communication device is not responsive to an attempted communication from said dominant communication device, a user of said dominant communication device being enabled to record a message at said message center when said subservient communication device is not responsive to the attempted communication from said dominant communication device, said subservient communication device being limited to communication with said dominant communication device, said secondary communication device, and said message center when disabled, said subservient communication device being enabled when, after being disabled, it establishes communication with one of said dominant communication device, said secondary communication device, and said message center.

11. The system of claim 10 wherein said subservient communication device establishes communication with said message center by way of said dominant communication device.

12. A system comprising:
a subservient communication device adapted to be enabled and disabled, said subservient communication device being fully functional when enabled; and
a dominant communication device adapted for communication with said subservient communication device, said dominant communication device adapted to disable said subservient communication device when said subservient communication device is not responsive to an attempted communication from said dominant communication device, said subservient communication device being limited to communication with said dominant communication device when disabled, said subservient communication device being enabled when, after being disabled, it establishes communication with said dominant communication device.

13. A method for disabling and enabling a subservient communication device using a dominant communication device, the subservient communication device being fully functional when enabled and being limited to communication with the dominant communication device and a secondary communication device when disabled, said method comprising the steps of:
disabling the enabled subservient communication device when it is not responsive to an attempted communication from the dominant communication device; and
enabling the disabled subservient communication device when it establishes communication with the dominant communication device or the secondary communication device.

14. The method of claim 13 wherein said step of disabling is accomplished at the discretion of a user of the dominant communication device.

15. The method of claim 13 further comprising the step of prompting a user of the dominant communication device to record a message at a message center when the subservient communication device is not responsive to the attempted communication from the dominant communication device.

16. The method of claim 15 further comprising the step of forwarding a communication from the disabled subservient communication device that is intended for the dominant communication device to the message center.

17. The method of claim 16 further comprising the step of providing the subservient communication device access to the message.

18. The method of claim 17 wherein the subservient communication device establishes communication with the dominant communication device for the purpose of enabling said subservient communication device when the subservient communication device accesses the message.
